(19) United States
(12) Patent Application Publication
(10) Pub. No.: US 2025/0000308 A1
(43) Pub. Date: Jan. 2, 2025

(54) SOAP BAR FOR SOAP DISPENSER

(71) Applicant: Odonata International Limited, Cardiff (GB)

(72) Inventor: Lisa HICKS, Monmouth (GB)

(73) Assignee: Odonata International Limited, Cardiff, Wales (GB)

(21) Appl. No.: 18/701,208

(22) PCT Filed: Oct. 13, 2022
(86) PCT No.: PCT/GB2022/052614

§ 371 Date: Apr. 12, 2024

(30) Foreign Application Priority Data
Oct. 13, 2021 (GB) 2114658.4
Oct. 13, 2021 (GB) 2114659.2

(51) Int. Cl. A47K 5/09

(52) U.S. Cl. CPC A47K 5/09

(57) ABSTRACT

To provide dispensability in a grater a bar of soap is provided having a generally cuboid shape having a central hole running through the length of the bar to provide an axis of rotation. This enables the bar to be reliably rotatably ground. An end surface feature may promote grating at the end of the bar. Corresponding methods of manufacture are disclosed.

### FIELD OF THE INVENTION

The present invention relates to a soap bar for use in a soap dispenser, and more particularly, where a dispenser receives the bar of soap and dispenses particles of soap resulting from the bar of soap being ground by a grinder located inside of the dispenser.

### BACKGROUND OF THE INVENTION

Solid soap bars are well known. However, they can be messy to use and are not ideal for communal situations.

Soap dispensers which dispense liquid detergent or soap are commonly used in communal situations. However, liquid detergent typically has a mass of 6 times as much as the equivalent amount of solid soap (largely due to the water content) which must be transported with a corresponding carbon footprint. It is also generally supplied in single use plastic containers, which have an environmental impact. Solid soap would be environmentally preferable.

Soap dispensers for receiving a bar of soap and for grinding the bar of soap to dispense particles of soap to a user, have been proposed.

For example, one such known dispenser uses a coil with spikes on it, to act as a grinder for a bar of soap that is inserted into the dispenser. The bar of soap is pushed down by a spring, and the coil turns in a circular motion to grate the bar of soap.

Another known dispenser uses a spring to push a bar of soap against a turning grater.

Solid soap is not the easiest material to work with and known proposed solid soap dispensers generally suffer from the disadvantage that the bar of soap dispenses chunks or slivers of soap, is not grated evenly and accurately and not in a uniform manner, particularly as the soap wears or is exposed to moisture and accordingly have not achieved general acceptance.

Accordingly, the invention is aimed at still achieving the environmental benefits of using a solid bar of soap rather than liquid soap, but at the same time, improving the known dispensers which use a solid bar of soap.

In particular, the invention is aimed at creating a bar of soap which works very well in such a dispenser, dispensing easy to use powder, and much better than if a conventional bar of soap were to be used.

### SUMMARY OF THE INVENTION

The present invention provides a bar of soap having a generally cuboid shape having a length, a thickness and a width, and having a hole running centrally through the length of the bar from a top surface to a bottom surface to provide an axis of rotation.

The use of a hole at the centre of the bar of soap helps greatly to reduce the mounding of soap that would occur if the hole were not present. Without the hole, the area at the very centre of the soap would not grate as the distance travelled against the grater at the very centre is insufficient to cause effective grating even with a coarser grater at the centre. This causes a mounding effect which resists the soap outside this area from making effective contact with the grater preventing the soap from being reliably grated as the material accumulates. This also results in an accumulation of soap at the centre of the bar, which can cause jamming of the dispenser elements, which in turn will prevent the remainder of the surface of the soap touching the grater, thus resulting in no soap particles being dispensed.

Preferably the hole has a volume which is at least 1% of the volume of the bar. Preferably the hole has a diameter of at least 5 mm. This provides a hole of sufficient volume/size to ensure reliable centering. Desirably the hole volume is at least 5% of the bar volume. This helps ensure enough of a void to ensure that ground material does not cause a problem.

Preferably the hole has a volume which is no more than 15% of the volume of the bar. Preferably the diameter is no more than 20 mm. This ensures that there is an efficient provision of active soap for a given packing volume.

A useful range of effective centering and avoidance of problems with ground material coupled with packing efficiency is thus achieved with a volume in the range 1 to 15% or sometimes 5 to 12% of the bar volume and/or a diameter in the range 5 to 20 mm, preferably 7 to 15 mm, or about 10 mm.

Preferably, the dimensions of the generally cuboid shape are in the range of about 50 mm to 100 mm tall by about 20 mm to about 50 mm thick by about 50 mm to about 75 mm wide. Although generally cuboid, the edges which rotate about the centre may be rounded and the face may be recessed or carry embossing. The term generally cuboid as used herein is preferably intended to encompass such forms with rounded or trimmed edges or corners or recesses or decorative features. Particularly desirably dimensions are approximately 65 mm by 33 mm by 66.5 mm or 60 mm depth/width by 64 mm high by 30-32 mm wide which provide a convenient dispensable quantity and packing size but the bar can also be in a range of such values 25% higher or lower.

Preferably, the diameter of the hole is in a range of approximately 5 mm to 20 mm.

Further preferably, the diameter of the hole is approximately 10 mm.

Preferably, the bar is adapted to work within a soap dispenser, such that the orientation of the central hole is parallel with the central axis of rotation of the soap dispenser.

Preferably, the soap dispenser has two nipple protrusions, and the bar of soap is adapted such that the nipple protrusions fit inside of the top and bottom surfaces of the hole.

Preferably, the hole has elongated areas at the top and bottom surfaces.

Preferably, the volume of the hole is at least about 1% of the volume of the bar.

Preferably, the volume of the hole is no more than 15% of the volume of the bar.

Preferably, the volume of the hole is in the range of 2-10% of the volume of the bar.

Preferably, the hole has a surface area on the top and bottom surfaces which is approximately 15% of the surface area of each of the top and bottom surfaces of the bar, but this can vary between 10% and 20%.

Preferably, edges of the bar of soap are rounded, with an angle of approximately 15 to 20 degrees. Further preferably, the angle is approximately 16 degrees.

The rounded edges make holding the soap a more ergonomic and comfortable experience during the entire time that the bar of soap is being handled by a user, so from the time the bar is taken out of the packaging to the time it is inserted into the dispenser or used manually outside of a dispenser for washing hands. The rounded edges also help to reduce the chances of the rotating soap bar contacting the inside surfaces of the dispenser housing during operation of the dispenser.

Preferably, the bar of soap has indented sides, with an angle of indentation being within a range of 1.5 to 5.5 degrees. Preferably, the angle is about 3.5 degrees.

The indented sides allow for the user to securely, firmly, and comfortably hold the soap when removing it from its packaging and when inserting it into the soap dispenser. The indented sides also reduce the risk of the sides of the soap bar contacting the inside surfaces of the housing of the dispenser as the soap bar rotates during operation of the dispenser.

A bar of soap as above, makes the bar much easier to insert into the dispenser, and much easier to use manually outside of such a dispenser, because it is much easier to pick it up by hand and makes the bar of soap work much better in the dispenser.

The through hole may be of uniform diameter but optionally it may be (slightly) tapered. Preferably the hole has a taper. Preferably the taper results in the diameter at one end being no more than 2 mm greater than the diameter at the other end or no more than about 20% different. This allows the bar to be formed by moulding around a tapered pin which can be more readily withdrawn but means the bar can be inserted either way up without affecting performance.

The invention also extends in another aspect to a method of forming a bar of soap comprising providing a generally cuboid mould having dimensions in the range of 20-50 mm thick by 50-100 mm long by 50-75 mm wide from at least two mould halves, providing a removable tapered pin having a minimum diameter of at least 5 mm and a maximum diameter of 20 mm and no more than 75% of the thickness of the mould to extend centrally along the long axis of the mould, filling the mould with soap bar precursor material with the pin inserted, causing the soap bar to solidify, withdrawing the pin and opening the mould and ejecting the soap bar with a formed through hole.

The soap also has functional etching in the top and bottom of the bar. The term “etching” is used to denote any indented pattern having the effect of causing discontinuities in the surface of the soap without limiting to the method of formation. The “etching” may also be referred to as a surface feature. This may be formed in the initial moulding process or subsequently machined away or embossed. This enables the soap to easily deliver powder on the grater from the first turn and to allow a second bar above the first to grind the previous bar through in its entirety ensuring no wastage or blockage to the device. The etching should produce weak spots so that the lower surface breaks up and is grated. Preferably the etching is at least 0.5 mm deep. Preferably the etching is no more than 2 mm deep. Advantageously the etching contains a plurality of lines extending generally away from the central hole. While the etching may be a simple geometric design advantageously this etching takes the form of a logo or decoration. Alternatively simple lines in the soap may be used. This feature allows the final part of the bar to break up from the pressure of the bar above and be fully ground through the dispenser on rotary motion.

The composition of the soap is within a specific range that results in effective powder formation. Delivering powder granules of 2 mm or less, and ideally 1 mm or less, gives the most effective lather from the soap with minimal user effort.

It is found that using a combination of oils that deliver a hard soap that grates well is obtained when the soap has a final water content of 15% or less and preferably is thoroughly cured. Final glycerin content is preferably below 10% and ideally below 8%. Preferably the soap is cured and/or has a final water content such that on exposure to an atmosphere of 100% humidity at 20 C for 24 hours the water content of the soap remains below 15%.

Optional and preferred features of other aspects may be combined with the method aspect and vice versa.

### BRIEF DESCRIPTION OF THE DRAWINGS

FIG. 1 is a diagram showing a soap dispenser housing, in which the bar of soap of the preferred embodiment is advantageously used;

FIG. 2 is a diagram showing the feeder legs element and the circular feeder element, which are to be inserted inside of the housing of FIG. 1;

FIG. 3 shows the overall feeder element of FIG. 2 inserted into the housing of FIG. 1;

FIG. 4 shows the handle which is located at the top of the housing of FIG. 1;

FIG. 5 shows the top surface of the feeder legs element;

FIG. 6 shows the insertion of a bar of soap into the housing;

FIG. 7 shows the grating element;

FIG. 8 shows the grating element inserted into the housing of FIG. 1;

FIG. 9 shows the bar of soap at the bottom of the dispenser, being ground into particles by the grater, according to a preferred embodiment of the present invention;

FIG. 10 shows the two nipples used to vertically align the bar of soap within the housing;

FIG. 11 shows a bar of soap, arranged to work with the dispenser, according to a preferred embodiment of the present invention;

FIG. 12 shows the bar of soap in cross section according to a preferred embodiment;

FIG. 13a shows a perspective view of the bar of soap with indented sides according to a preferred embodiment; and

FIG. 13b shows a top view of the bar of soap of FIG. 13a.

FIG. 14a shows an end view of the bar of soap of FIG. 13a with an indentation in the form of a logo;

FIG. 14b shows the logo of FIG. 14a in perspective.

### DETAILED DESCRIPTION OF THE PREFERRED EMBODIMENTS

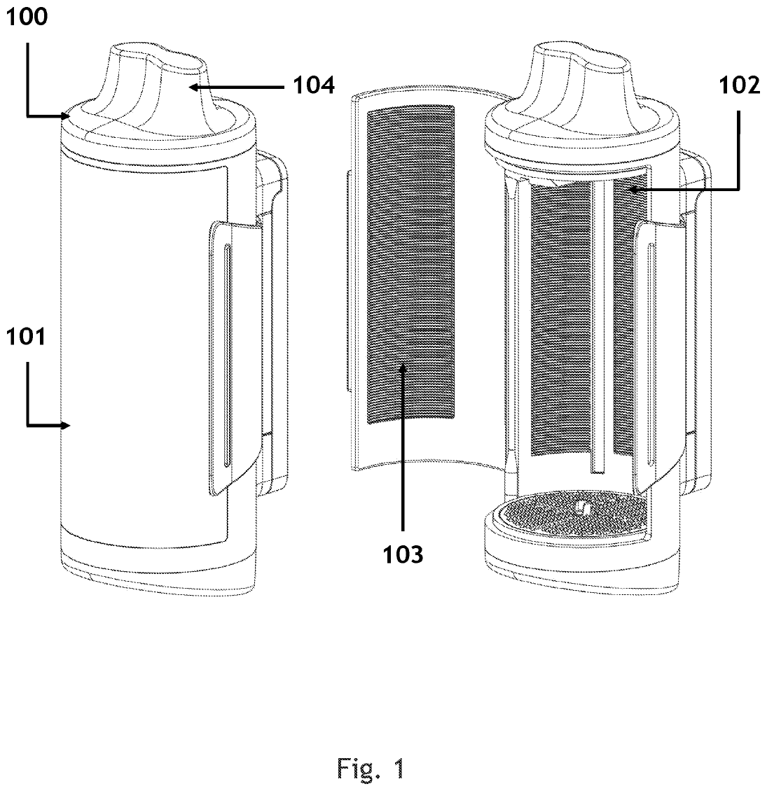

FIG. 1 shows a soap dispenser housing 100 for receiving at least one bar of soap which is to be ground into fine particles by the dispenser.

As shown in FIG. 1, a door 101 is provided for covering the front opening of the dispenser, and when the door is in the open position, at least one bar of soap can be inserted into the opening.

The inside wall 102 of the housing of FIG. 1 is provided with threads, arranged in a diagonal orientation so that they slope downwards. The threads can be located, for example, on the inside wall 103 of the door and on the back inside wall of the housing 102.

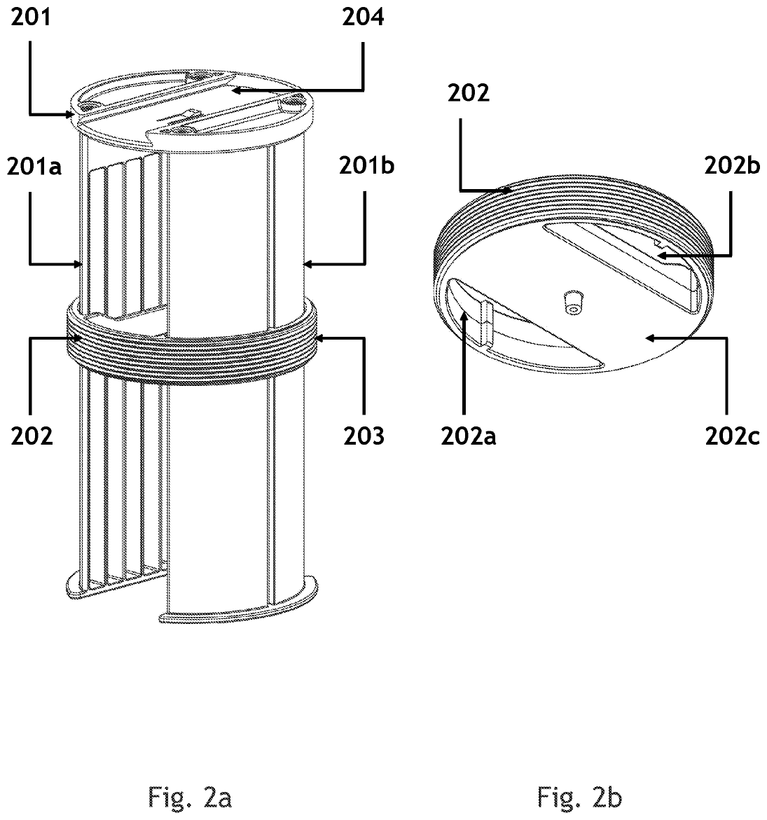

As shown in FIG. 2a, an element 201 having two parallel vertical legs (201a, 201b) is provided for insertion inside of the housing of FIG. 1, in the below description, this will be called the feeder legs element 201. A circular feeder element 202 which is a ring-shaped element with a flat undersurface 202c (shown in FIG. 2b) engages with the feeder legs element 201 such that the vertical legs 201a, 201b of the feeder legs element 201 fit into the holes 202a, 202b (shown in FIG. 2b) in the circular feeder element, so that when the feeder legs element 201 rotates, the circular feeder element 202 also rotates. This circular feeder element 202 has threads 203 on it, with the threads running in the circumferential direction of the circular ring, as shown in FIG. 2a.

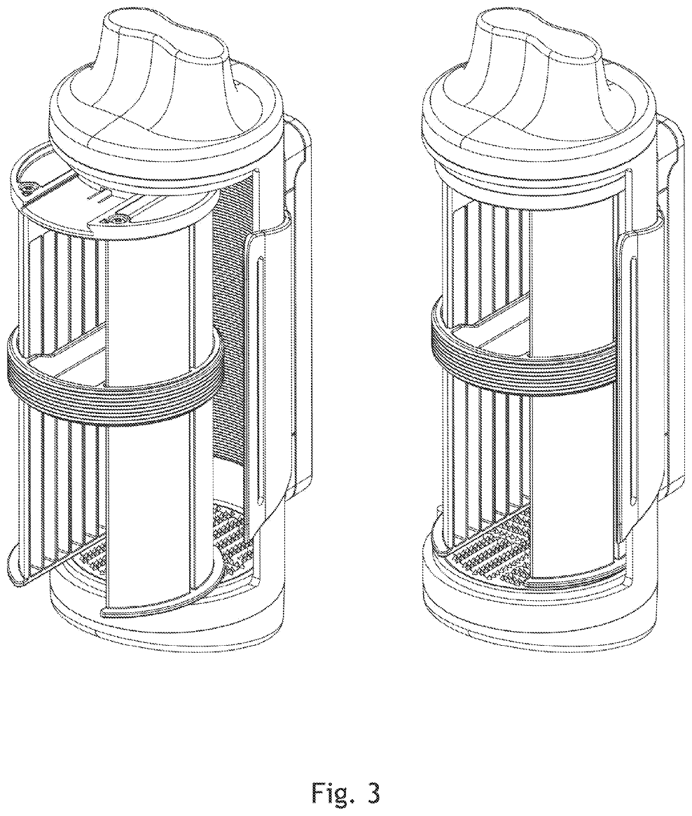

This overall feeder element, the combination of the feeder legs element and the circular feeder element, slides into the housing of FIG. 1, such that the threads of the circular feeder element 202 engage with the threads on the inside walls of the housing. FIG. 3 shows the overall feeder element of FIG. 2a inserted into the housing of FIG. 1. It should be noted that the user does not generally completely remove the combination of the feeder legs element and the circular feeder element from the housing, and instead the user moves forward the combination of the feeder legs element and the circular feeder element to a position slightly outside of the housing, to disengage the threads on the circular feeder element from the threads of the housing. This allows the user to easily load a bar of soap into the housing of the dispenser. Finger grips (indentations) can be formed in the side of the feeder legs element, to facilitate the user moving forward the feeder assembly as just described.

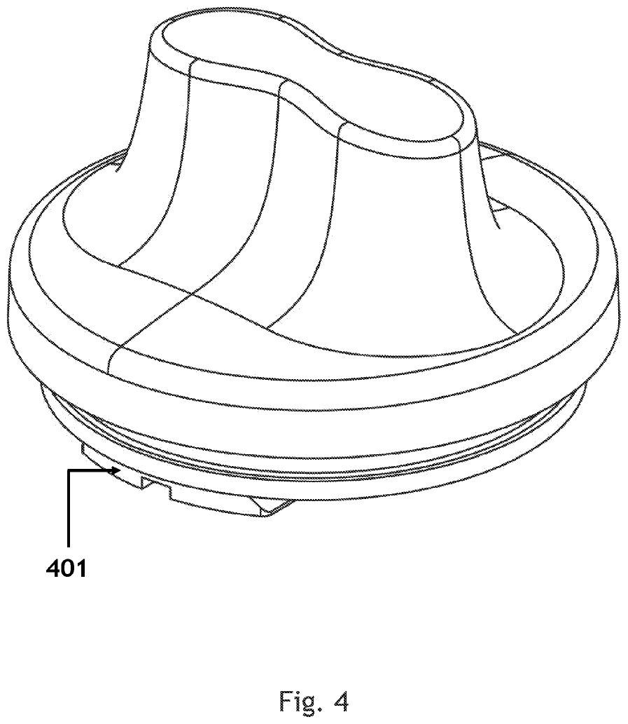

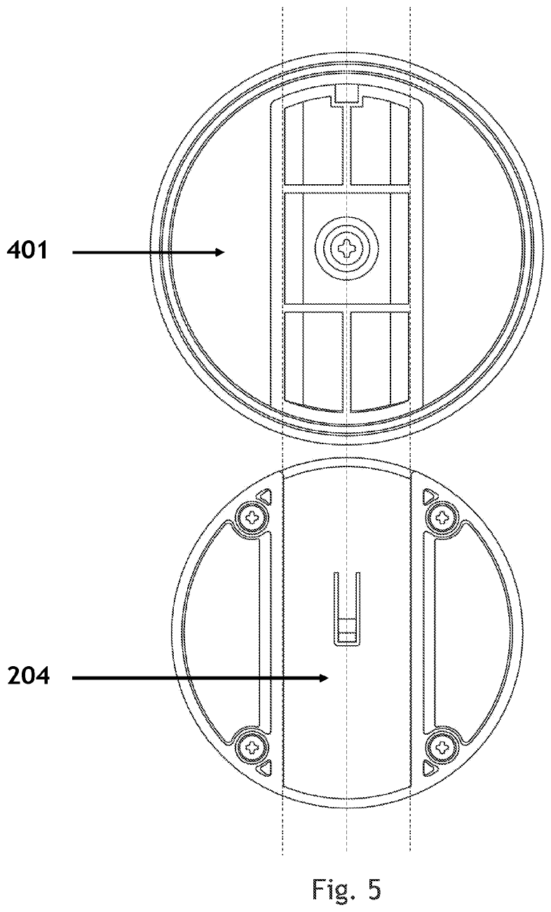

The housing of FIG. 1 has a handle 104 on top, which can be turned by hand. In an alternative embodiment, it can also be turned by a motor under battery operated (or plug in to the mains electricity supply) control. This handle, as shown in FIG. 4, has an elongated protrusion 401 of a size that fits into indentation 204 on the top surface of the feeder legs element as shown in FIG. 5.

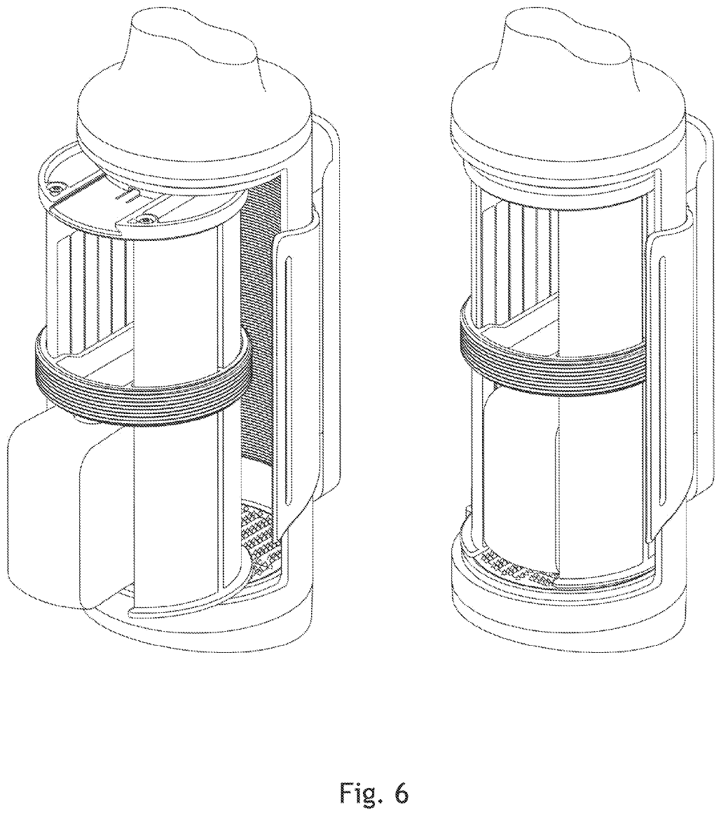

As shown in FIG. 6, when the door of the housing is open, a user inserts at least one bar of soap into the space between the two parallel vertical legs of the feeder legs element.

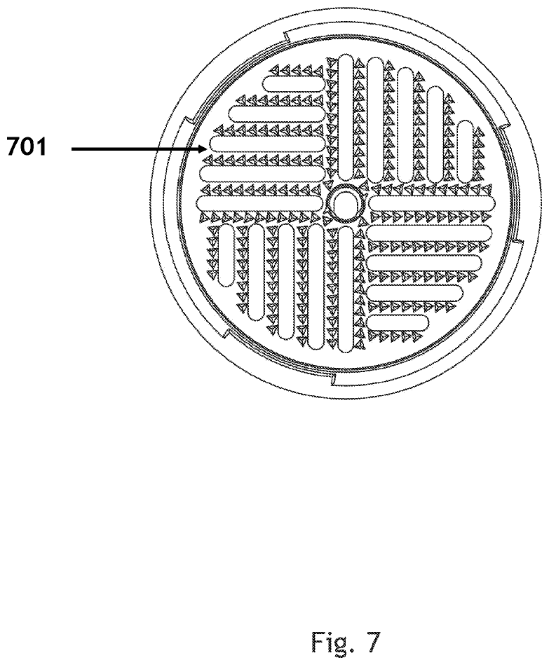

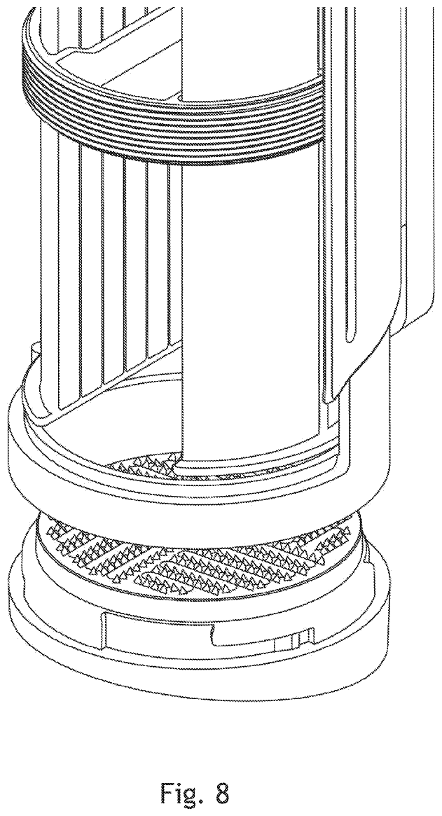

A grating element 701, shown in FIG. 7 is used to grate the bar of soap. This grating element is inserted into the bottom of the dispenser, during production of the soap dispenser, as shown in FIG. 8. In the preferred embodiment, it is not intended to be removable by the user.

In operation of the soap dispenser, the user turns the handle 104 at the top of the dispenser and this turning motion turns the feeder legs element 201 because the elongated protrusion 401 in the handle is forced against the indentation 204 on the top surface of the feeder legs element 201, by the turning action of the handle 104, causing the feeder legs element 201 to rotate.

The rotating of the feeder legs element 201 also rotates the circular feeder element 202, as was described above. The threads 203 of the circular feeder element engage with the threads on the inside surface of the dispenser housing, to direct the circular feeder element 202 downwards towards the bottom of the housing towards the grater 701, along the path of the threads. The circular feeder element 202 rotates around the inside of the housing in a circular motion, guided by the threads.

The bar of soap (or a plurality of bars of soap, stacked one on top of the other), then is forced downwards (because it is being pushed downwards by the flat undersurface 202c (of FIG. 2b) of the circular feeder element 202) whilst being rotated by the rotation of the circular feeder element 202.

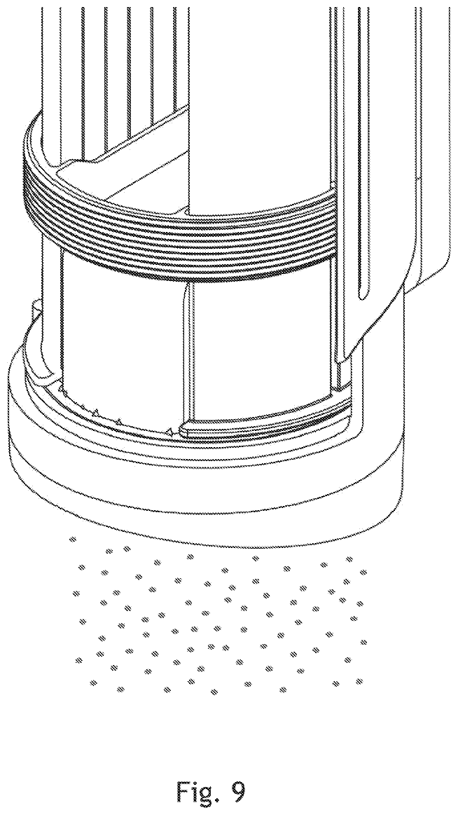

The bar of soap eventually reaches the grater 701, and the bottom surface of the bar of soap is then evenly grated by the grater, such that fine particles of soap are then ejected from the bottom of the dispenser, as shown in FIG. 9.

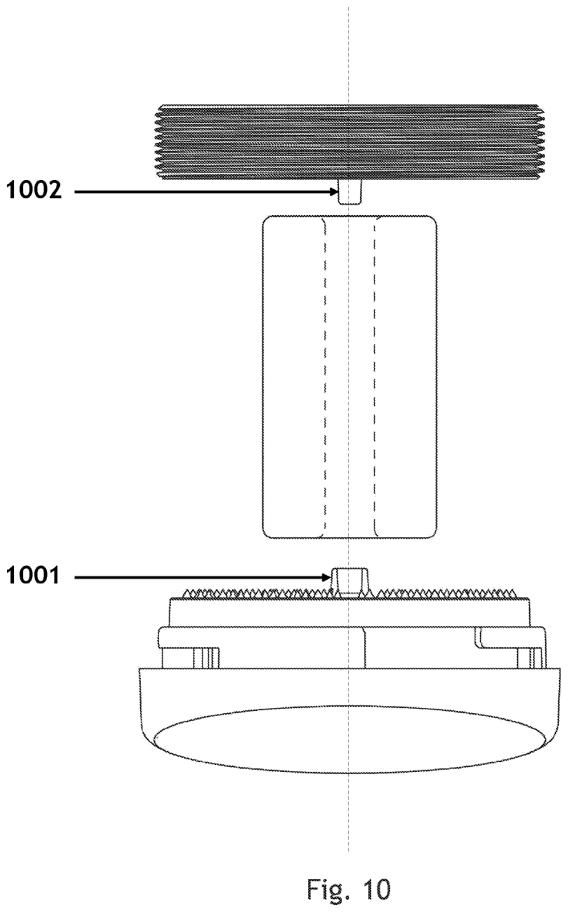

As shown in FIG. 10, there are two nipples (or protrusions), one nipple 1001 at the centre of the top surface of the grater 701, and the other nipple 1002 at the centre of the undersurface 202c of the circular feeder element 202 to hold the bar of soap into position to maintain its alignment during motion within the dispenser. This ensures that a maximum surface of the soap contacts the grater, to stop the bar of soap from sliding out of position. For example, this stops the bar of soap from getting caught in the threads at the back wall of the dispenser or on the inside door. This arrangement helps to guide the bar of soap in an accurate manner towards the grater.

The use of the threads, and the movement of the circular feeder element along the threads, and the use of the feeder legs element to provide rotation from the handle, helps to guide the bar of soap down towards the grater in a very even, uniform, manner, to make maximum use of the bar of soap in creating fine particles for washing.

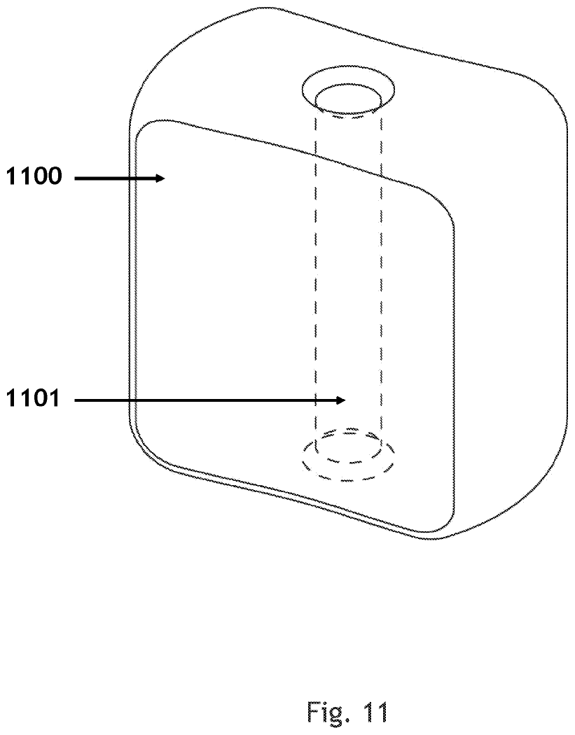

According to a preferred embodiment of the present invention, FIG. 11 shows a bar of soap which is arranged to work well with the dispenser described above.

As shown in FIG. 11, the bar of soap has a central hole 1101 running from top surface of the bar of soap to the bottom surface thereof, of approximately 1/28 th of the volume of the bar of soap and represents approximately 15% of the surface area of each of the top and bottom surfaces of the bar of soap.

In the preferred embodiment, the dimensions of the cuboid bar of soap are approximately 66.5 mm by 65.0 mm by 33 mm (but these dimensions can also vary within a range of 20% higher or lower than these stated values), and the diameter of the hole is 10 mm. The hole preferably runs through the whole length of the soap bar on the 65 mm plane. When the soap bar is inserted into the dispenser, the hole is oriented parallel with the central axis of rotation of the dispenser. Alternatively, the bar of soap is 64 mm×64 mm×33 mm, with an 8 mm diameter hole.

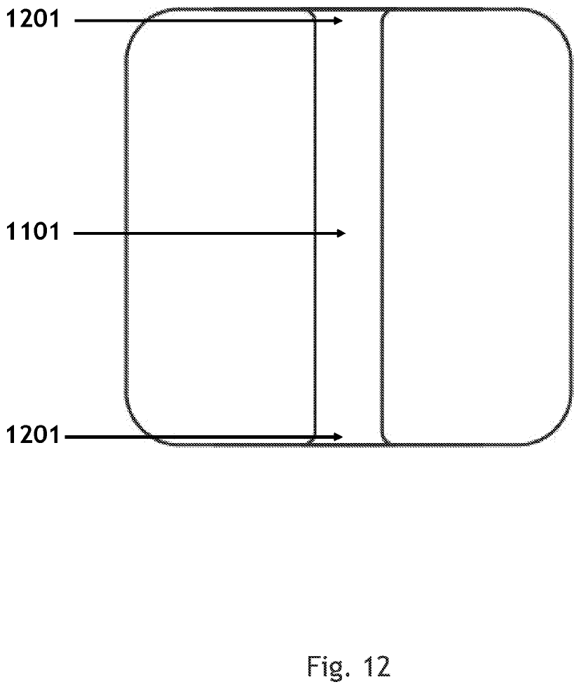

This central hole is shown in cross-section in FIG. 12. As shown in FIG. 12, the hole is preferably not a straight hole but instead is elongated at the top and bottom (see the elongated areas 1201). These elongated areas 1201 helps to make the bar of soap self-righting on the nipple at the centre of the grating of the dispenser as well as to the nipple on the underside of the circular feeder element, keeping the soap from gathering inside the thread on the inside of the dispenser wall and the inside of the door.

The use of a hole at the centre of the bar of soap helps greatly to reduce the mounding of soap that would occur if the hole were not present. Without the hole, the area at the very centre of the soap would not grate as it does not rotate against the grater at the very centre, this causes a mounding effect which would prevent the soap outside this area from making contact with the grater preventing the soap from being grated. This also results in an accumulation of soap at the centre of the bar, which can cause jamming of the dispenser elements, which in turn will prevent the remainder of the surface of the soap touching the grater, thus resulting in no soap particles being dispensed.

The hole may be formed by moulding with a removable pin. This is advantageous to provide efficient manufacture with minimal wastage. Alternatively it may be formed by drilling from a solid bar.

The size of the diameter could be altered within a range between 5 mm and 20 mm. For example a 5 mm diameter hole assuming a bar of soap of 66 mm×65 mm×33 mm, and the central hole running in the 66 mm direction may be used. For a 20 mm diameter hole, the volume of the hole is approximately 1/7^{th} of the total volume of the bar of soap. The range of proportions of the volumes of the hole to the volume of the bar of soap is preferably between 1% to 15%. Preferably, this should be at least about 1% and should be no more than 15%. A further preferred range is 2% to 10%. If the diameter of the hole is too small, the soap around the edge of the hole will not be positioned above the grating surface, and this results in the mounding effect described above. However, if the hole is too large, the bar of soap won't fit securely on the nipples, and it would also call into question the integrity of the overall bar of soap, as the bar of soap could split from the hole to the outer edge of the bar or break apart altogether.

As shown in FIGS. 11 and 12, the edges of the bar of soap can be rounded.

The rounded edges make holding the soap a more ergonomic and comfortable experience during the entire time that the bar of soap is being handled by a user, so from the time the bar is taken out of the packaging to the time it is inserted into the dispenser or used manually outside of a dispenser for washing hands. The rounded edges also help to reduce the chances of the rotating soap bar contacting the inside surfaces of the dispenser housing during operation of the dispenser.

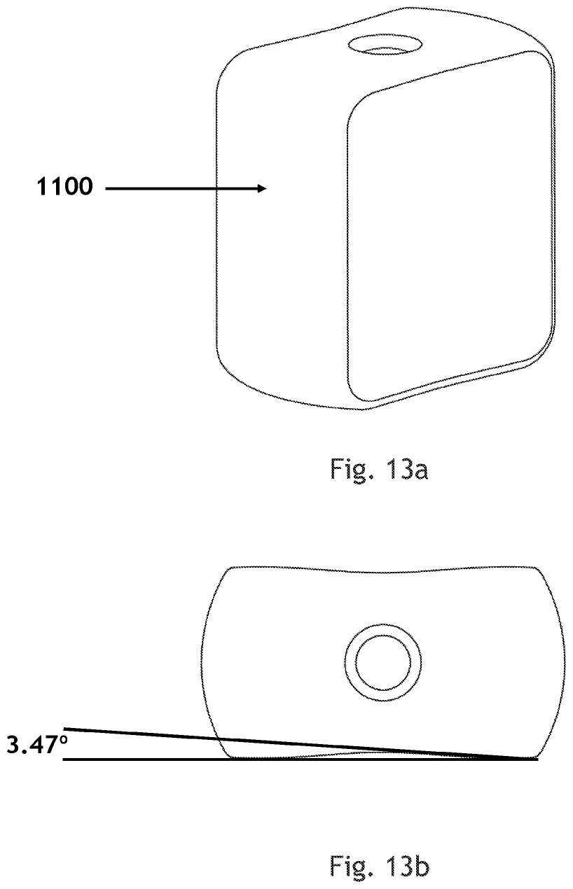

As shown in FIG. 13a and FIG. 13b, the bar of soap can have indented sides, with an angle of indentation being preferably about 3.5 degrees (shown in the FIG. 13b as being 3.47 degrees), but which could be within a range of 1.5 to 5.5 degrees.

The indented sides allow for the user to securely, firmly, and comfortably hold the soap when removing it from its packaging and when inserting it into the soap dispenser. The indented sides also reduce the risk of the sides of the soap bar contacting the inside surfaces of the housing of the dispenser as the soap bar rotates during operation of the dispenser. However, while advantageous, they are not essential.

A bar of soap designed to these new specifications make the bar much easier to insert into the dispenser, and much easier to use manually outside of such a dispenser, because it is much easier to pick it up by hand and makes the bar of soap work much better in the dispenser, as described above.

The bar of soap may be made of any materials traditionally used in soap making, such as fat and alkali (the alkali most common used is sodium hydroxide or potassium hydroxide).

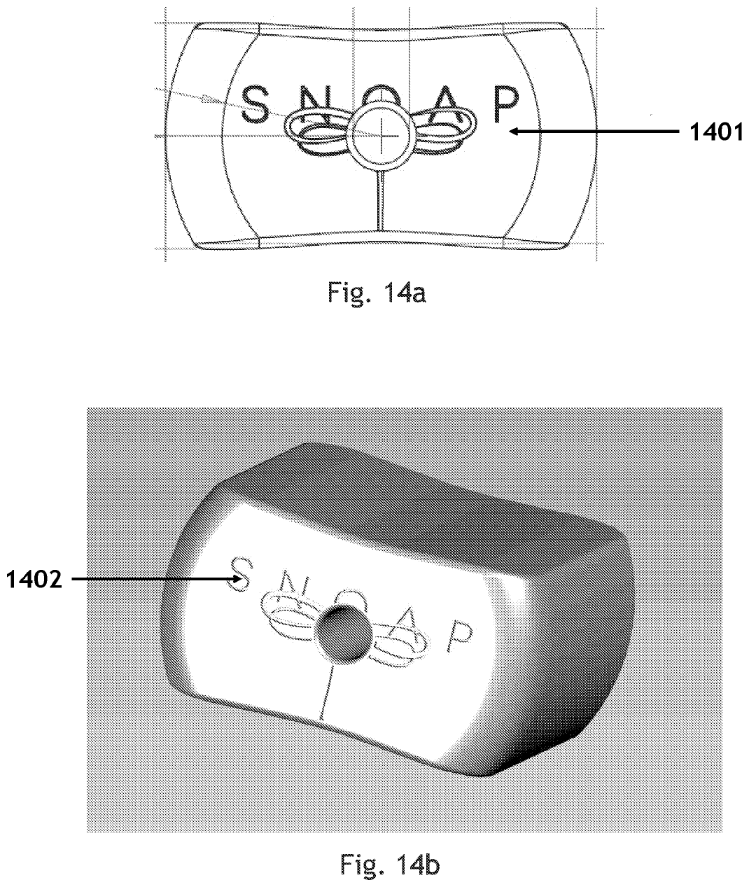

Referring to FIGS. 14a and 14b, the soap has functional etching 1400 in the top (and also not shown in the bottom) end of the bar. The term “etching” is used herein to denote any indented pattern causing discontinuities without limiting to the method of formation. This may be formed in the initial moulding process or may be subsequently machined away or may be embossed. This feature enables the soap to easily deliver powder on the grater from the first turn and to allow a second bar above the first to grind the previous bar through in its entirety ensuring no wastage or blockage to the device. Without such etching it is found that the end of the bar may form a sliver or disc of soap that cannot be ground through the machine. The etching should produce weak spots so that the lower surface breaks up and is grated. Preferably the etching is at least 0.5 mm deep. Preferably the etching is no more than 2 mm deep. Advantageously the etching contains a plurality of lines extending generally away from the central hole. While the etching may be a simple geometric design advantageously this etching takes the form of a logo or decoration. Alternatively simple lines in the soap may be used. This feature allows the final part of the bar to break up from the pressure of the bar above and be fully ground through the dispenser on rotary motion.

The composition of the soap is within a specific range that results in effective powder formation. Delivering powder granules of 2 mm or less, and ideally 1 mm or less, gives the most effective lather from the soap with minimal user effort.

It is found that using a combination of oils that deliver a hard soap that grates well is obtained when the soap has a final water content of 15% or less and preferably is thoroughly cured. Final glycerin content is preferably below 10% and ideally below 8%. Preferably the soap is cured and/or has a final water content such that on exposure to an atmosphere of 100% humidity at 20 C for 24 hours the water content of the soap remains below 15%.

The properties of the soap and of the surface feature can readily be verified. If the soap is not sufficiently solid to grate after exposure to moisture then it is known to increase the dryness/hardness of the soap with a change in oil composition (and/or reduction of glycerin). If it is found that the soap does not reliably break up at the end on rotation, then the depth and or quantity of lines in the surface feature should be increased. The illustration in FIG. 14a works well with the parameters given for water content and glycerin content so is a useful guide to the appropriate pattern density.

1. A bar of soap having a substantially cuboid shape having a length, a thickness and a width and having a clear hole of at least 5 mm diameter running centrally through the length of the bar of soap from a first end having a top surface to a second end having a bottom surface, the clear hole arranged to receive a spindle or nipple at each end to define an axis of rotation, wherein at least one end of the first and second ends of the bar of soap has a surface feature including a plurality of lines at least 0.5 mm deep that provide discontinuity in the surface to promote fragmentation of the soap on rotation of the bar about the axis of rotation over a grating element.

2. The bar of soap of claim 1, wherein the hole has a volume which is at least about 1% of the volume of the bar of soap, preferably at least about 5%.

3. The bar of soap of claim 1, wherein the plurality of lines extend generally away from the central hole.

4. The bar of soap claim 1, wherein the hole has a volume of at most 15% of the volume of the bar of soap.

5. The bar of soap of claim 1, wherein the hole has a diameter of at most about 20 mm, preferably at most about 15 mm.

6. The bar of soap of claim 1, wherein the substantially cuboid shape has a length in the range of 55 to 85 mm, a width in the range of 50 to 75 mm and a thickness in the range of 20 to 45 mm.

7. The bar of soap of claim 1, wherein the diameter of the hole is at least about 8 mm, preferably approximately 10 mm.

8-9. (canceled)

10. The bar of soap of claim 1, wherein the plurality of lines extend across the at least one end of the bar of soap on at least one of the top and bottom surfaces.

11. The bar of soap of claim 1, wherein the edges of the bar of soap are rounded or chamfered.

12. The bar of soap of claim 1, wherein the bar of soap has indented sides.

13. The bar of soap of claim 1, wherein the volume of the hole is in the range of 2-10% of the volume of the bar of soap.

14. The bar of soap of claim 1, wherein the hole has a surface area on the top and bottom surfaces which is between 2 and 10% of the area of the respective surface.

15. (canceled)

16. The bar of soap of claim 1, having a surface feature at both ends.

17. The bar of soap of claim 1, wherein the surface feature includes a logo.

18. The bar of soap of claim 1, having a final water content of less than 15% and glycerin content below 10%.

19. The bar of soap of claim 1, cured and having a surface texture such that on exposure to an atmosphere of 100% humidity at 20 C for 24 hours, the water content remains below 15%.

20. A method of forming a bar of soap comprising providing a substantially cuboid mould having dimensions in the range of 20-50 mm thick by 50-100 mm long by 50-75 mm wide from at least two mould halves, providing a removable tapered pin having a minimum diameter of at least 5 mm and a maximum diameter of 20 mm and no more than 75% of the thickness of the mould to extend centrally along the long axis of the mould, filling the mould with soap bar precursor material with the pin inserted, causing the bar of soap to solidify, withdrawing the pin and opening the mould and ejecting the bar of soap with a formed through hole.

21. The method of forming a bar of soap according to claim 20, wherein the ejected bar of soap has a substantially cuboid shape having a length, a thickness and a width and having a clear hole of at least 5 mm diameter running centrally through the length of the bar of soap from a first end having a top surface to a second end having a bottom surface, and the method comprises forming a surface feature including a plurality of lines at least 0.5 mm deep that provide discontinuity in the surface of at least one of the ends of the bar of soap to promote fragmentation of the soap on rotation of the bar about the axis of rotation over a grating element.

22. A system for producing powdered soap comprising the bar of soap of claim 1 and a soap dispenser having a central axis of rotation, two nipple protrusions and a grating element, wherein the orientation of the clear hole is parallel with the central axis of rotation of the soap dispenser and the bar of soap is adapted such that the nipple protrusions fit inside of the top and bottom surfaces of the clear hole, wherein the soap dispenser is arranged to rotate the bar of soap about the central axis of rotation and urge the end of the bar of soap having the surface feature against the grating element to produce granules of 2 mm or less on rotation of the bar of soap relative to the grating element.
